(19) United States
(12) Patent Application Publication
(10) Pub. No.: US 2020/0044206 A1
(43) Pub. Date: Feb. 6, 2020

(54) Carrying Device Having an Energy Store and an Electrical Transformer

(71) Applicant: Wacker Neuson Produktion GmbH & Co. KG, Munich (DE)

(72) Inventors: Michael Steffen, Munchen (DE); Christian Glanz, Dachau (DE); Patrick Diller, Baar-Ebenhausen (DE); Rudolf Berger, Grunwald (DE)

(73) Assignee: Wacker Neuson Produktion GmbH & Co. KG

(21) Appl. No.: 16/523,354

(22) Filed: Jul. 26, 2019

(30) Foreign Application Priority Data
Jul. 31, 2018 (DE) 10 2018 118 552.9

(51) Int. Cl. H01M 2/10

(52) U.S. Cl. CPC H01M 2/1005; H01M 2220/30; H01M 2/105

(57) ABSTRACT

A carrying device includes a carrying frame, an energy store carried by the carrying frame, a transformer device, carried by the carrying frame, for transforming an electric current drawn from the energy store, and an electrical connection device, carried by the carrying frame, for connecting the carrying device to a consumer. The carrying device is in the form of a shoulder bag or backpack having at least one strap for wearing the carrying device over one or both shoulders of a user.

### BACKGROUND OF THE INVENTION

### Field of the Invention

The invention relates to a carrying device having an energy store and an electrical transformer. In particular, the invention relates to a portable energy store for electric tools or for electrically operated work machines.

### Description of the Related Art

Storage-battery backpack systems are known, which are available both as exchangeable systems (for exchanging the storage batteries) and as systems with a permanently installed storage battery. The storage battery, or rechargeable battery, serves here as an energy source or energy store for a consumer. As the electrical output of these systems, the DC voltage of the storage battery is made available, which, at a connected work apparatus, is then switched either directly to a drive motor or is fed to an intermediate circuit of a downstream frequency transformer, which then drives a three-phase motor in the work apparatus.

Systems of this kind are known for example from DE 43 01 508 A1, DE 20 2012 013 284 A1, and DE 20 2013 102 928 A1.

Especially on construction sites, work apparatuses having multiphase drive motors are frequently used. For these motors, the direct current at the electrical output of the storage battery is not suitable, however. As a result, an additional frequency transformer has to be provided on the work apparatus, resulting in increased design complexity, increased costs, and—if the frequency transformer is attached directly to the work apparatus—an increased weight of the work apparatus.

### SUMMARY OF THE INVENTION

The invention is based on the object of avoiding or reducing the complexity that thus exists in the prior art.

The object is achieved according to the invention by providing carrying device comprising a carrying frame, an energy store carried by the carrying frame, and a transformer device that is carried by the carrying frame and that transforms an electric current drawn from the energy store. The carrying device additionally includes an electrical connection device, carried by the carrying frame, for connecting the carrying device to a consumer.

The carrying frame, which represents an essential constituent of the carrying device, can be embodied in any desired way, for example as a support plate, carrying framework, or the like.

The energy store carried by the carrying frame can be in particular a rechargeable storage battery, known per se, i.e. a rechargeable electric battery. The carrying frame furthermore carries the transformer device for transforming an electric current drawn from the energy store. The energy store in this case supplies in particular a direct current, which can be transformed by the transformer in a suitable manner as regards the voltage and/or the frequency. Especially in order to actuate a three-phase motor of a work apparatus (consumer) that is connectable to the carrying device, it is necessary to provide the current to the work apparatus with a suitable characteristic.

Typically, the transformer device is a frequency transformer that is known per se and can convert both the voltage and the frequency of the direct current supplied by the energy store, with the result that an alternating current with a higher or lower voltage and a changed frequency is able to be generated. The transformer device is in this case electrically connected to the energy store.

A single-phase or multiphase current with a special frequency and/or special voltage can thus be generated from the direct current coming from the energy store. The transformer device is therefore part of the carrying device.

A transformer device should be understood as being a component that converts direct current into a current with a frequency greater than zero, i.e. into an alternating current.

Finally, the electrical connection device for connecting the consumer is also carried by the carrying frame. The consumer is in particular a work apparatus, for example an electric tool, an internal vibrator for concrete compaction, etc. The connection device can be embodied for example in the manner of an outlet or connection socket. In this case, the connection contacts may, if necessary, be concealed under an openable flap in order to protect them from external influences when not in use. The work apparatus can be connected to the connection device (for example the outlet) with the aid of a suitable plug contact (for example a plug).

The connection device can have one or more possibilities for connecting one or more consumers.

The energy store, the transformer device, and the connection device can all be carried by the carrying frame, wherein, to achieve this purpose, it is also possible to provide intermediate elements, fastening devices or elements, holding devices, receptacles, etc. for actually fastening these components to the carrying frame. It is therefore not absolutely necessary for the energy store to be fastened directly to the carrying frame. Rather—like the other components—it can be mechanically coupled to the carrying frame in a suitable manner by a fastening device.

The energy store can in particular be fastened to the carrying frame in an exchangeable manner. It is then easily detachable, possibly without the aid of further tools. For example, it can be removed from the carrying frame by a user by actuation of a locking device, for example a latch, and replaced with a further energy store. In order to ensure reliable electrical contact between the energy store and the receptacle provided therefor, it may be expedient to carry out the fastening of the energy store to the carrying frame in the manner of a plug-in movement.

The plug-in movement can take place for example from above and an unplugging movement directed correspondingly in the opposite direction can take place upwardly. In this case, the energy store can be retained reliably, with its entire weight, in the receptacle. The changing of the energy store takes place upwardly via an upper opening of the receptacle.

The energy store and the transformer device can form a structural unit and for example be fastened jointly to the carrying frame in an exchangeable manner. The structural unit can for its part, in one variant, be able to be taken apart without tools, for example after being detached from the carrying frame. Likewise, however, it is also possible for the structural unit to be configured such that the energy store and the transformer device can be taken apart and thus separated only with a tool, optionally only by a skilled person.

The carrying device can be in the form of a shoulder bag or backpack, having at least one strap, serving as a shoulder strap, for carrying the carrying device over a shoulder of a user. The strap can thus be in the form of a carrying strap such that the user can wear the carrying device comfortably on their shoulder, with the result that they are relieved of difficult carrying work. The carrying device configured in such a way thus forms a storage-battery backpack system with a frequency transformer, wherein—as explained further below—a second strap can also be provided in order to increase wearing comfort. The shoulder strap can also be in the form of a dimensionally stable hoop that is worn over the shoulder.

The strap can be fastened to the carrying frame at at least two fastening points in order to allow the carrying frame to be worn safely.

In one variant, two straps are provided, for wearing the carrying device over both shoulders of a user. In this case, the carrying device is in the form of a backpack. The two straps are fastened with their ends to respective fastening points on the carrying frame, specifically in the upper region of the carrying frame and in the lower region of the carrying frame. The user can pull the two straps over their two shoulders and thus wear the carrying device comfortably on their back. It may be expedient to provide corresponding cushioning on the straps or on the side of the carrying frame that faces the user, in order to allow the user to wear the carrying device as comfortably as possible.

In the backpack-like configuration of the carrying device, it may be expedient for the components of energy store, transformer device and/or connection device to be held on the rear side of the carrying frame, i.e. on the side of the carrying frame that faces away from the user.

In addition, a waist strap (also known as a waist belt) connected to the carrying frame can be provided, in order to improve wearing comfort. As is normal in hiking backpacks, a large part of the backpack weight (here: the weight of the entire carrying device) is supported on the user's hips with the aid of the waist strap, with the result that the back and shoulders are relieved of load. Given the considerable weight of the energy store and of the transformer, it is thus likewise advantageous for a part of the weight to be supported directly on the user's hips via the waist strap.

In one variant, either the energy store or the transformer device can be fastened to the waist strap and thus to the carrying frame. In this variant, although this respective energy store or the transformer device is still carried by the carrying frame, the weight force of the component can in this case also be supported directly on the user's hips. The respectively other component then remains on the carrying frame, in particular on the rear side or the side of the carrying frame that faces away from the user.

The waist strap extends in this case substantially horizontally from the carrying frame and is preferably fastened to respective fastening points in the lower region of the carrying frame. The waist strap can in this case also be in two parts and in particular a left-hand strap half can be for the user's left hip side and a right-hand part for the user's right hip side. The two strap halves can, if necessary, be connected together by the user in front of their stomach with the aid of a suitable buckle. The waist strap can also be configured in a very stiff manner, for example in the manner of a hip support—optionally divided into two parts here too—so that the hip support or the two support parts can be supported on the user's hips.

In one variant, a switching device carried by the carrying frame can be provided, for switching an electrical connection between the energy store and the transformer device. The switching device is thus in particular capable of establishing the electrical connection (“on”) or disconnecting it (“off”). In this case, it is possible for the switching device to be manually actuated by the user, for example by operating a switch or a button. Likewise, automatic switching is alternatively or additionally possible, as will be explained further below.

In one embodiment, a detection device can be provided on the connection device, for detecting whether a consumer (for example a work apparatus) is connected, wherein the detection device can be coupled to the switching device such that the switching device is only closable when a consumer connected to the connection device is detected. Thus, it is possible in particular for the presence, optionally also the type or kind of connected consumer, to be detected by the detection device.

The detection device can for example be in the form of a kind of sensor, which detects whether a plug of the consumer has been plugged into the connection device (for example an outlet). Only in this case can the switching device be closed in order to form the electrical connection between the energy store and the transformer device.

If the detection device can also detect the type of consumer, it is possible for example to ensure that the switching device is only closed when the consumer provided for the particular purpose has been connected to the connection device. If, by contrast, a consumer that is not suitable has been connected, the switching device remains blocked, and so accidental energizing of the consumer is ruled out.

In this case, it is possible in particular for the switching device to be automatically closable when the consumer connected to the connection device is detected as being for the particular purpose.

In all variants, a switching device can be provided that is set up to selectively switch the power supply between the energy store and the connection device.

To this end, the switching device can for example selectively establish and/or interrupt a flow of current between the at least one energy store and the transformer device. Furthermore, the switching device can alternatively establish and/or interrupt a flow of current between the transformer device and the connection device. Furthermore, the switching device can also be arranged within the energy store, such that the terminals of the energy store can be switched into a deenergized state during an exchange and thus there is no risk to a user.

The consumer itself, i.e. for example the work apparatus, can for its part likewise have a power switch, in order that the user can selectively switch the apparatus on and off. In this case, the switching device on the carrying device therefore does not serve for switching the work apparatus on and off, but only for safely energizing and deenergizing the connection device.

Further variants are possible, in which at least one of the following further components is carried by the carrying frame:

Thus, a charging device for the energy store can be provided, in order to charge the energy store for example on a public network, in particular when the carrying device is temporarily not being used.

This charging device can for example also be in the form of a photovoltaic device (solar cells), in order to allow the energy store to be charged even during operation.

It is also possible for a heating device for providing heat for the user to be fastened to the carrying frame. The heating device can for example be a hot-air blower. Likewise, however, the heating device can also have heating elements that are worn by the user on their body or in their clothing (“heating pad”, back warmer, shoe warmer, glove warmer, etc.).

It is also conceivable to provide a cooling device for providing refrigeration or a cooling action for the user. In this case, this can be a cooling unit or a fan, etc.

Also possible is a lighting device, in order to allow spot lighting or extensive lighting of the working area. Furthermore, a low-voltage connection device (USB port, power bank, 5 V phone charger) can also be provided.

The abovementioned components can all be powered by the energy store, and so it is not necessary to keep a separate storage battery available.

### BRIEF DESCRIPTION OF THE DRAWINGS

These and further advantages and features of the invention will be explained in more detail in the following text by way of examples with reference to the accompanying figures, in which:

FIG. 1 shows a schematic side view of a carrying device in the form of a backpack with an energy store and a transformer device;

FIGS. 2 to 5 show different variants of the carrying device in FIG. 1, likewise in side view.

### DETAILED DESCRIPTION

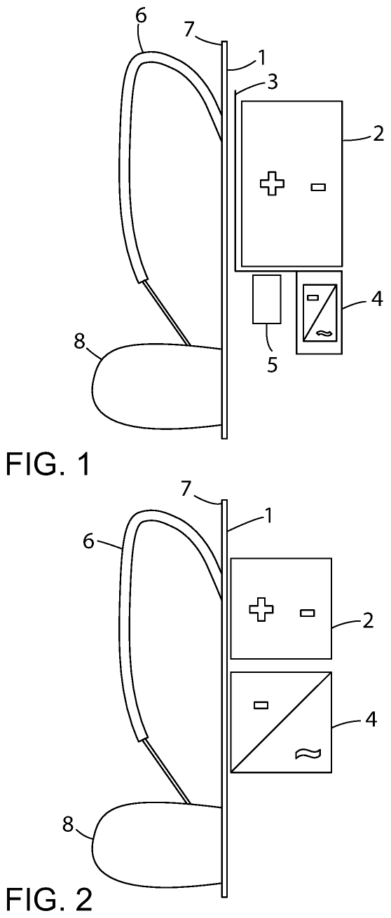

FIG. 1 shows a schematic side view of a carrying device, configured in the manner of a backpack having a carrying frame 1, which may be configured, for example, as a support plate or carrying framework.

Fastened to the rear side, facing away from the user, of the carrying frame 1 is a storage battery 2 that serves as an energy store. The storage battery 2 can be accommodated in a battery receptacle 3 that is provided specifically therefor and serves as a fastening device, and can thus be fastened to the carrying frame 1. The battery receptacle 3 can for example be in the form of an introduction slot or introduction well or of a battery housing, into which the storage battery 2 is plugged from above in an exchangeable manner. When the storage battery 2 is drained, it can be removed from the battery receptacle 3 and replaced with a fresh storage battery 2.

The storage battery 2 can be held in the battery receptacle 3 with the aid of a locking device that is not illustrated, such that it is held reliably in any position of the carrying frame 1. The locking device can, to this end, have for example a latch, a flap, a pin or the like, in order to hold the storage battery 2 in particular in a form-fitting manner.

Furthermore, the carrying frame 1 carries a frequency transformer 4 that serves as a transformer device. The frequency transformer 4 can also be accommodated in its own housing, which is fastened to the carrying frame 1 via a fastening device. In this case, it is possible to fasten the frequency transformer 4 permanently or exchangeably to the carrying frame 1.

Furthermore, an outlet 5 that serves as a connection device is attached to the carrying frame 1. The outlet 5 can be a CEE outlet, to which a corresponding work apparatus (not shown in FIG. 1), for example an internal vibrator for concrete compaction, can be connected. In particular, the work apparatus is plugged into the outlet 5 with its plug (likewise not illustrated in FIG. 1), and in this way be supplied with the alternating current at the suitable frequency that is provided by the frequency transformer 4.

Fastened to the carrying frame 1 are two carrying straps 6, only one of which is visible in the side view in FIG. 1. The second carrying strap 6 is located therebehind in the plane of the drawing. The two carrying straps 6 can be configured similarly to the carrying straps on a typical hiking backpack and have for example cushioning in order to allow the user to wear the carrying device comfortably on their two shoulders. The carrying straps 6 are fastened with their respective ends to the upper side and to the underside of the carrying frame 1.

At the upper end of the carrying frame 1, a carrying handle 7 can be provided, in order to make it easier for the user to carry the carrying device in their hand.

Attached to the underside of the carrying frame 1 is a waist strap 8. The waist strap 8, too, can be configured in a similar manner to the one on a hiking backpack, in order to afford the user a comparable level of comfort. In particular, the waist strap 8 is suitable for supporting a considerable part of the total weight on the user's hips. As a result, the user's back and shoulders are relieved of load.

The waist strap 8 is in two parts and has a left-hand and a right-hand strap half, wherein only the left-hand strap half is visible in FIG. 1. The two strap halves can be closed to form an encircling strap by a conventional buckle in front of the user's stomach.

The waist strap 8 can also be in the form of a simple hip support, for example in the form of a half-shell, i.e. not as an encircling strap. In this case, it is also possible to provide only two support surfaces by way of the waist strap 8, via which a certain supporting action on the user's hips is possible.

FIG. 2 shows a variant of the arrangement in FIG. 1. In this case, the storage battery 2 and the frequency transformer 4 are fastened to the support plate 1 separately from one another. The outlet 5 is not illustrated for clarity.

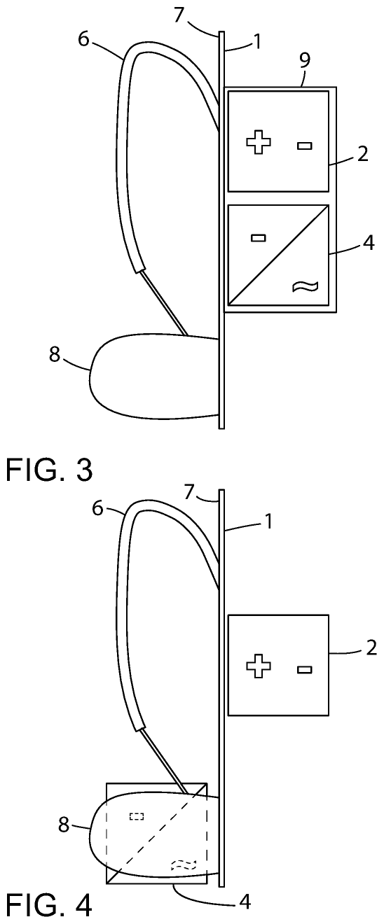

FIG. 3 shows a further variant, in which the storage battery 2 and the frequency transformer 4 form a structural unit 9. The entire unit 9 can be removed from the carrying frame 1 and also fastened thereto again. In this way, it is possible to exchange the storage battery 2 and the frequency transformer 4 at the same time.

FIG. 4 shows a further variant, in which the storage battery 2 is carried by the carrying frame 1. The frequency transformer 4 is fastened to the waist strap 8 and is carried on the carrying frame 1 thereby.

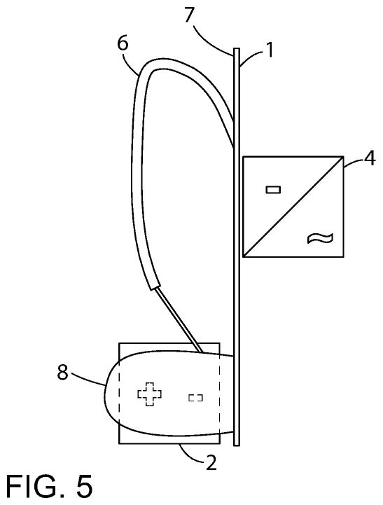

FIG. 5 shows a reversal of the design in FIG. 4. In this case, the frequency transformer 4 is attached to the rear side of the carrying frame 1, while the storage battery 2 is fastened to the waist strap 8 and is held on the carrying frame 1 thereby. In this case, it is also possible for two storage batteries 2 to be provided, which are attached to the left-hand and to the right-hand part of the waist strap 8. Of course, it is also possible for several units of storage batteries 2 to be carried in a distributed manner by the carrying device, and thus also, in addition to the storage batteries in FIG. 5, for example on the rear side of the carrying frame 1.

Thus, in a further variant that is not shown in the figures, a combination of the arrangement in FIGS. 2 and 5 is possible, in which three (or more) storage batteries 2 are installed, specifically both on the rear side of the carrying frame 1 and on the waist straps 8.

In all variants, a switching device that is not shown in the figures can be provided, which is set up to selectively switch the power supply between the storage battery 2 and the connection device 5. To this end, the switching device can for example selectively establish and/or interrupt a flow of current between the at least one storage battery 2 and the frequency transformer 4. Furthermore, the switching device can alternatively establish and/or interrupt a flow of current between the frequency transformer 4 and the connection device 5. Furthermore, the switching device can also be arranged within the storage battery 2, such that the terminals of the storage battery 2 can be switched into a deenergized state during an exchange and thus there is no risk to a user.

1. A carrying device comprising:
a carrying frame;
an energy store that is carried by the carrying frame;
a transformer device that is carried by the carrying frame and that transforms an electric current drawn from the energy store; and
an electrical connection device, carried by the carrying frame, for connecting the carrying device to a consumer.

2. The carrying device as claimed in claim 1, wherein the energy store is fastened to the carrying frame in an exchangeable manner.

3. The carrying device as claimed in claim 1, wherein the energy store and the transformer device form a structural unit and are fastened jointly to the carrying frame in an exchangeable manner.

4. The carrying device as claimed in claim 1, wherein the carrying device comprises a shoulder bag or backpack having at least one strap for wearing the carrying device over a shoulder of a user.

5. The carrying device as claimed in claim 4, wherein the strap is fastened to the carrying frame.

6. The carrying device as claimed in claim 1, wherein two straps are provided for wearing the carrying device over both shoulders of a user.

7. The carrying device as claimed in claim 1, further comprising a waist strap connected to the carrying frame.

8. The carrying device as claimed in claim 7, wherein either the energy store or the transformer device is fastened to the waist strap and thus to the carrying frame.

9. The carrying device as claimed in claim 1, further comprising a switching device that is carried by the carrying frame and that switches an electrical connection between the energy store and the transformer device.

10. The carrying device as claimed in claim 1, further comprising
a detection device that is provided on the connection device and that detects whether a consumer is connected to the connection device; and wherein
the detection device is coupled to the switching device such that the switching device is only closable when a consumer is connected to the connection device is detected.

11. The carrying device as claimed in claim 10, wherein the switching device is automatically closable when the connection of a consumer to the connection device is detected.

12. The carrying device as claimed in claim 1, wherein at least one of the following further components is carried by the carrying frame:
a charging device for the energy store,
a photovoltaic device for charging the energy store,
a heating device for providing heat,
a cooling device for providing refrigeration,
a lighting device, and
a low-voltage connection device.
